(19) United States
(12) Patent Application Publication
(10) Pub. No.: US 2012/0254365 A1
(43) Pub. Date: Oct. 4, 2012

(54) DELIVERY OF STREAMING MEDIA CONTENT

(75) Inventors: Venkata S. Adimatyam, Irving, TX (US); Sameer Vasant Gavade, Irving, TX (US); Laxmi Ashish Arte, Austin, TX (US)

(73) Assignee: VERIZON PATENT AND LICENSING, INC., Basking Ridge, NJ (US)

(21) Appl. No.: 13/077,255

(22) Filed: Mar. 31, 2011

(51) Int. Cl. G06F 15/16

(52) U.S. Cl. 709/219

(57) ABSTRACT

A device includes a communication interface and one or more processors. The communication interface may receive media guide data, from a media guide server via a network, including information relating to a number of available media items and playlist information relating to at least one available playlist file associated with a particular media item. The one or more processors may receive a user selection of the particular media item and may request the playlist file from a playlist server via the network based on the playlist information via the interface. The interface may receive the playlist file from the playlist server, the playlist file including locations of stream segments corresponding to the selected playlist. The one or more processors may request the stream segments from a content server via the network based on the received playlist file.

### BACKGROUND

Many of today's entertainment or communication-related electronic devices rely on receiving, transmitting, and/or using streaming digital data or content. For example, a set-top box may receive broadcast television programs and/or video-on-demand (VOD) that is streamed from a content provider. A personal computer may receive a stream of a video clip over the Internet. A soft phone may receive streaming audio data over a suitable link/channel that is established over an Internet Protocol (IP) or other packet-based network. As a number of available media streams increases, loads placed on serving content files and associating data files also increases, requiring corresponding increases in network capacity and robustness.

### BRIEF DESCRIPTION OF THE DRAWINGS

FIG. 1 illustrates an exemplary system for streaming content;

FIG. 2 illustrates exemplary components of one or more devices depicted in FIG. 1;

FIG. 3 is an exemplary functional block diagram of components implemented in the inserter of FIG. 1;

FIG. 4A illustrates an exemplary playlist of FIG. 1;

FIG. 4B illustrates an exemplary variant playlist of FIG. 1;

FIG. 5 is an exemplary functional block diagram of components implemented in the IMG server of FIG. 1;

FIG. 6 is an exemplary functional block diagram of components implemented in the client device of FIG. 1; and

FIG. 7 is a flow diagram of exemplary processes according to implementations described herein.

### DETAILED DESCRIPTION

The following detailed description refers to the accompanying drawings. The same reference numbers in different drawings may identify the same or similar elements. As used herein, the term “content” may refer to audio and/or video content (e.g., a movie, a three-dimensional (3D) movie, show, television program, video stream, audio stream, Internet radio, broadcast of a live event (e.g., sporting event, concert, etc.)).

As described herein, content streaming systems may provide a number of different streams of an identical piece of content, such as content streams corresponding to a number of different criteria, such as bandwidth, bit rate, resolution, etc. The system may receive (or retrieve) a content item (e.g., a movie or television show) and partition the stream into a plurality of segments corresponding to the each of the different streams. The system may also generate a file that identifies that different streams available for download. This files is sometimes referred to as a manifest file or variant playlist. The system also generates a number of playlist files corresponding to the number of variant streams indicated in the manifest file. The playlist files indicate the order in which the segments are to be played and identify the individual media files for download by client devices.

Consistent with embodiments described herein, the information contained in the manifest or variant playlist file (referred to herein as variant playlist or manifest information) may be transmitted to client devices along with media guide or program guide information. For example, client devices may periodically request guide information from a program guide server or other device. In some instances, the media guide information and variant playlist file may be pushed or otherwise automatically delivered to client devices, such as on a periodic basis, e.g., daily, hourly, etc. Then, depending on available bandwidth, resolution, memory, etc., a client/media player may identify a corresponding playlist file for retrieval based on the received manifest information. Corresponding media segments identified in the playlist files may then be downloaded and played back in a sequential manner.

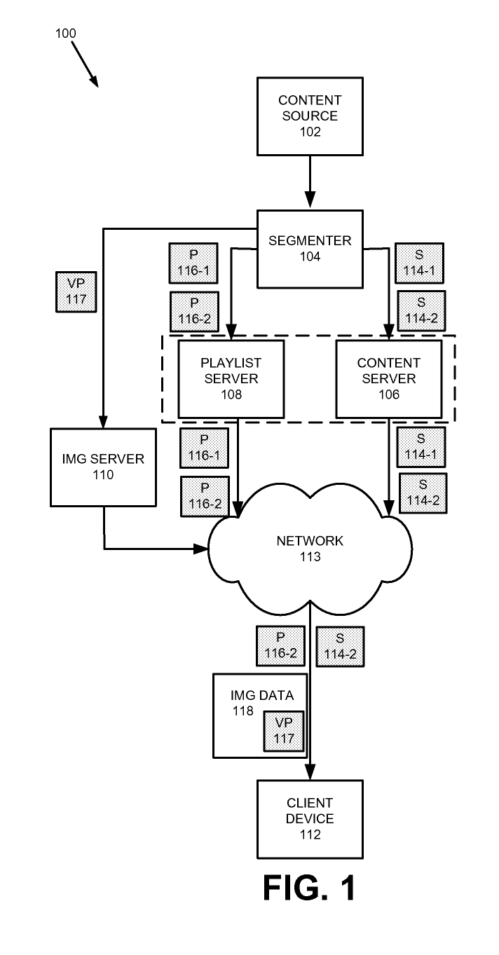

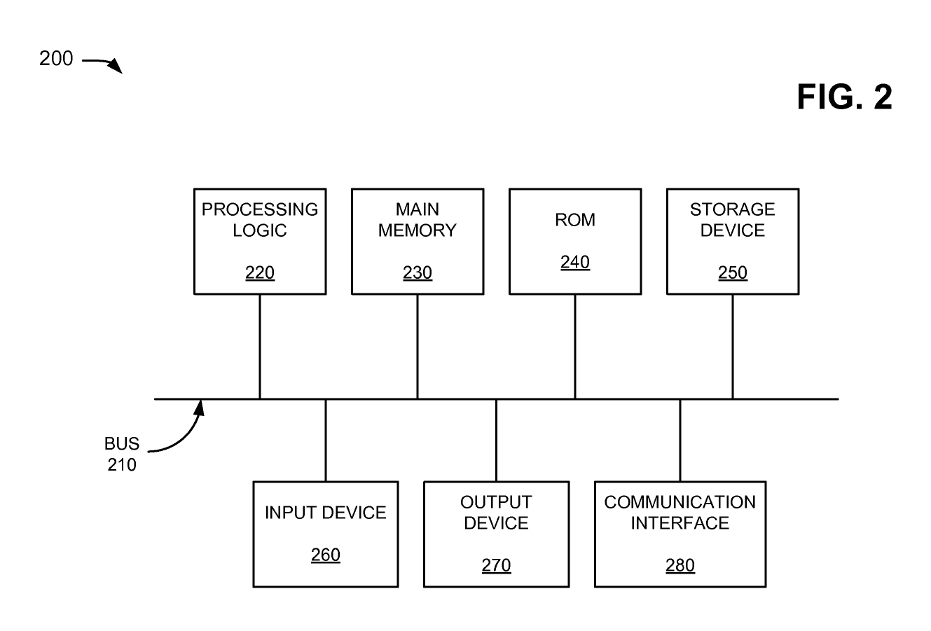

FIG. 1 is a block diagram of an exemplary network 100 in which systems and methods described herein may be implemented. As shown, system 100 may include a content source 102, segmenter 104, content server 106, playlist server 108, an interactive media guide (IMG) server 110, client device 112, and network 113. These components/devices are described below in greater detail with references to FIGS. 2-5.

Briefly, content source 102 may include a live or prerecorded audio or video source. An encoder (not shown) associated with content source 102 may receive a signal from source 102 and encode the media to include a format such as, for example, H.264, MPEG-4 Advanced Video coding (AVC), high efficiency advanced audio coding (HE-AAC), etc. Source 102 may send the encoded media in a transport stream (e.g., MPEG-2) to segmenter 104 for downstream processing.

Segmenter 104 may be configured to split a source content from content source 102 into a number of stream segments, shown as content segments 114-1, and 114-2 (collectively referred to as “segments 114”) in FIG. 1. As described above, in some instances, segmenter 104 may be configured to generate segments corresponding to more than one stream, such as a number of streams for differing quality, bitrates, output resolution, etc. This concept is schematically illustrated in FIG. 1 as segment group 114-1 associated with a first stream and segment group 114-2 associated with a second stream.

In addition, segmenter 104 may generate one or more playlists 116 (e.g., playlists 116-1 and 116-2) that indicate the order in which segments 114 are to be played for each respective stream and that additionally point to the locations of segments 114. As above in relation to the various segment groups 114, when segmenter 104 has generated information for multiple streams, segmenter 104 generates a corresponding number of playlists 116, referred to as playlist 116-1 and playlist 116-2 in FIG. 1.

When multiple media streams are provided for a single content item, segmenter 104 may also generate a file 117 that identifies the various available streams and their corresponding playlist files 116. Depending on the streaming protocol implemented, file 117 may be referred to by different names. For HTTP Live Streaming from Apple Inc., the file is referred to as a variant playlist (VP). For Smooth Streaming from Microsoft® the file is referred to as a manifest file or client manifest file (e.g., an .ismc file). For Adobe® Flash the file is referred to as a “smil” file. Although named and formatted differently, each of these file types includes similar types of information relating to identifying a number of different available streams for a particular content item. For ease of description, file 117 is referred to herein as variant playlist (VP) 117.

Stream segments 114 and playlists 116 may be distributed or served to client device 112 via content server 106 and playlist server 108, respectively, over network 113. It should be noted that, although content server 106 and playlist server 108 are shown as distributed or separate devices in FIG. 1, in other implementations these servers may be located/executed from the same physical server or group of servers. Consistent with implementations described herein, VP 117 may be transmitted or otherwise relayed to IMG server 110. As described herein, IMG server 110 may refer to any device or combination of devices configured to provide media guide information to client device 112 via network 113. As described below, IMG server 110 may provide program guide data (IMG Data) 118 associated with television or other multi-media programming to client devices 112.

Program guide data 118 may include any data that may be useful for generating and/or included in a program guide user interface, and/or metadata associated with such information. For example, program guide data 118 may include data related to (e.g., descriptive of) media content (e.g., from content source 102), program data, data descriptive of media content ordering information, data related to stations providing media content (i.e., station data), data related to channels used for transmission of media content (i.e., channel data), data related to scheduling of media content such as broadcast times and channels (i.e., schedule data), media ratings information, credits, casts, reviews, episode information, series information, show information, pay-per-view information, and any other information associated with media content.

Consistent with embodiments described herein, IMG server 110 may be configured to insert or otherwise include VP 117 within program guide data 118. For example, VP 117 may be associated with (e.g., as metadata) a guide listing associated with the particular content item from content source 102. In this manner, selection of the content item via the IMG provided at client device 112 results in corresponding retrieval/identification of VP 117.

Client device 112 may, based on various factors, such as available bandwidth and output resolution, select a particular stream identified in VP 117. Client devices 112 may access a particular playlist 116 (e.g., playlist 116-1) identified in VP 117 and may receive and play content segments 114 (e.g., segments 114-1) in accordance with the information provided in the particular playlist 116-1.

Depending on the implementation, system 100 may include additional, fewer, or different components than those illustrated in FIG. 1. For example, in one implementation, system 100 may include additional content sources 102, inserters 104, client devices 112, etc. Furthermore, although not illustrated in FIG. 1, in an actual implementation, system 100 may include different network components, such as switches, bridges, routers, gateways, firewalls, different types of client/server devices, etc.

FIG. 2 is an exemplary diagram of a device 200 that may correspond to any of segmenter 104, content server 106, playlist server 108, IMG server 110, and/or client device 112. As illustrated, device 200 may include a bus 210, processing logic 220, a main memory 230, a read-only memory (ROM) 240, a storage device 250, an input device 260, an output device 270, and a communication interface 280. Bus 210 may include a path that permits communication among the components of device 200.

Processing logic 220 may include a processor, microprocessor, or other type of processing logic that may interpret and execute instructions. Main memory 230 may include a random access memory (RAM) or another type of dynamic storage device that may store information and instructions for execution by processing logic 220. ROM 240 may include a ROM device or another type of static storage device that may store static information and/or instructions for use by processing logic 220. Storage device 250 may include a magnetic and/or optical recording medium and its corresponding drive.

Input device 260 may include a mechanism that permits an operator to input information to device 200, such as a keyboard, a mouse, a pen, a microphone, voice recognition and/or biometric mechanisms, remote control 130, etc. Output device 270 may include a mechanism that outputs information to the operator, including a display, a printer, a speaker, etc. Communication interface 280 may include a transceiver that enables device 200 to communicate with other devices and/or systems. For example, communication interface 280 may include mechanisms for communicating with another device or system via a network, such as network 160.

As described herein, device 200 may perform certain operations in response to processing logic 220 executing software instructions contained in a computer-readable medium, such as main memory 230. A computer-readable medium may be defined as a physical or logical memory device. The software instructions may be read into main memory 230 from another computer-readable medium, such as storage device 250, or from another device via communication interface 280. The software instructions contained in main memory 230 may cause processing logic 220 to perform processes described herein. Alternatively, hardwired circuitry may be used in place of or in combination with software instructions to implement processes described herein. Thus, implementations described herein are not limited to any specific combination of hardware devices, circuitry, and/or software.

Although FIG. 2 shows exemplary components of device 200, in other implementations, device 200 may contain fewer, different, or additional components than depicted in FIG. 2. In still other implementations, one or more components of device 200 may perform one or more other tasks described as being performed by one or more other components of device 200.

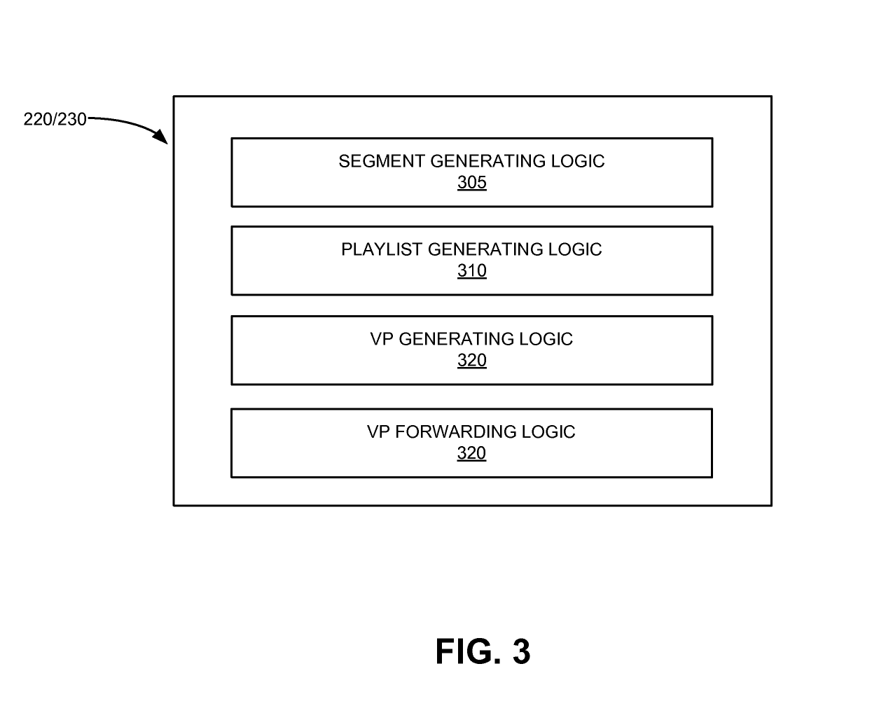

FIG. 3 is an exemplary functional block diagram of components implemented in segmenter 104. In an exemplary implementation, all or some of the components illustrated in FIG. 3 may be stored in memory 230. For example, referring to FIG. 3, memory 230 may include segment generating logic 305, playlist generating logic 310, variant playlist (VP) generating logic 315, and VP forwarding logic 320. In addition, various logic components illustrated in FIG. 3 may be implemented by processing logic 220 executing one or more programs stored in memory 230.

As described briefly above, segment generating logic 305 may include logic for generating segments for one or more video audio/streams. For example, as briefly described above, segment generating logic 305 may receive/retrieve an encoded source content item from content source 102 and generate even length stream segments corresponding to the source. The stream segments may be formatted based on the implemented streaming protocol (e.g., HTML Live Streaming, Smooth Streaming, Flash, etc.). In addition, as described above, segment generating logic 305 may generate segment files for multiple streams, such as streams having different bitrates, resolutions, etc. In some implementations, the stream segments may be stored as sequential transport stream (.ts) files. Segment generating logic 305 may store the generated stream segments on content server 106 for retrieval by client device 112.

Playlist generating logic 310 may include logic for generating a playlist file 116 corresponding to each stream. More specifically, playlist generating logic 310 may be configured to generate playlist files 116 identifying the location, duration, and sequence numbering of the segment files 114 corresponding to a particular stream. Playlist generating logic 310 may store the generated playlist files on playlist server 108 for retrieval by client device 112.

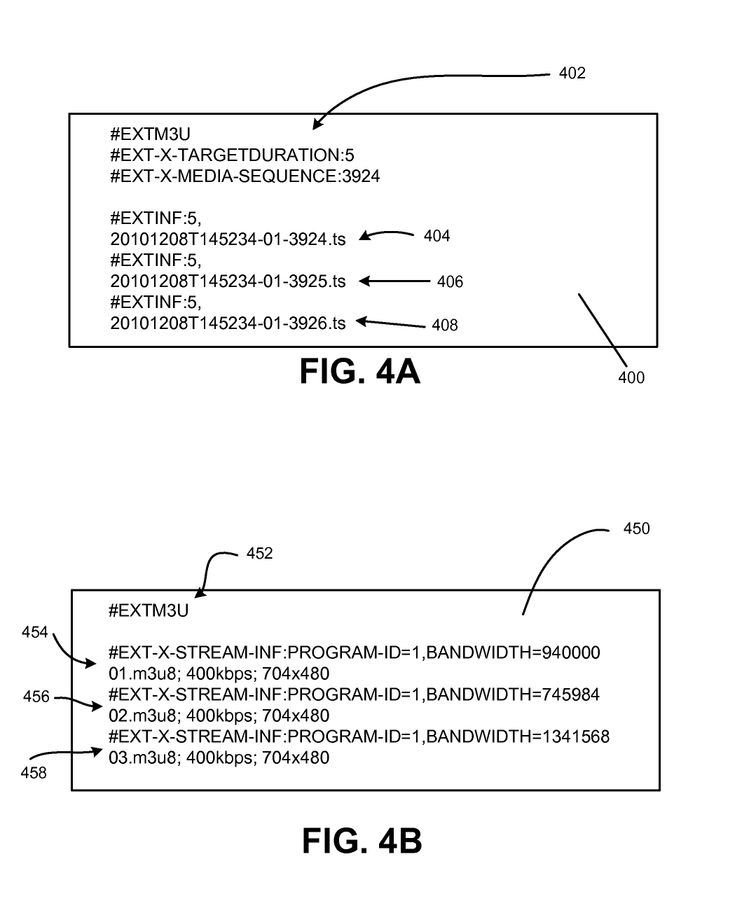

FIG. 4A shows an exemplary index file or a playlist file 400 that lists storage locations (e.g., universal resource locator (URL) or uniform resource identifier (URI), network addresses, etc.) of content file segments in an order that the segments are to be reassembled and/or output by client device 112. Examples of index/playlist files may include M3U8 files, M3U files, PLS files, Advanced Stream Redirector (ASX) files, etc.

As shown, playlist 400 may include header 402 and segment identifiers 404, 406, and 408. Playlist 400 is depicted for simplicity and does not include many components that may be present in other playlist files (e.g., M3U8 files). As shown, header 402 includes a #EXTM3U statement, #EXT-X-TARGETDURATION statement, and #EXT-X-MEDIA-SEQUENCE statement. #EXTM3U indicates the type of playlist/index file (e.g., extension to M3U).

Playlist file 400 is depicted as being in an extended M3U file format, including the comment character “#” preceding the tag “EXTM3U” in the first line 402, and an ordered list of content file segment identifiers indicated by the tags “EXT-X-STREAM-INF” in content segment identifiers 404-426. Other text files/protocols may be used. Playlist file 400 is depicted for simplicity and may include additional tags that may be defined by extended playlist file (e.g., M3U8) protocol.

#EXT-X-TARGETDURATION indicates the maximum duration of segments in playlist 116. In FIG. 4A, the maximum duration is shown as 5 seconds. #EXT-X-MEDIA-SEQUENCE indicates a minimum sequence number of any file (i.e., segment) in playlist 400. For example, in FIG. 4A, the minimum number is specified as 3924. In segment identifiers 404-408, the actual sequence numbers are 3924, 3925, and 3926, respectively, in strings 20101208T145234-01-3924.ts, 20101208T145234-01-3925.ts, and 20101208T145234-01-3926.ts.

Each of segment identifiers 404-408 includes a #EXTINF statement and a string (e.g., URL or URI). #EXTINF indicates the duration of the content segment. The string identifies a location of the segment. In some implementations, the URL or URI of the location string may be provided in non-relative format (e.g., https://www.server.com/ . . . ).

Returning to FIG. 3, variant playlist generating logic 315 may include logic for generating variant playlist (VP) 117 identifying the various available media streams 116 corresponding to the particular content item from content source 102. More specifically, VP generating logic 315 may be configured to generate may VP 117 that includes the identities, attributes, and locations of playlist files 116 corresponding to the available media streams.

FIG. 4B illustrates an exemplary VP 450. As shown, VP 450 may include header 452 and stream identifiers 454, 456, and 458. VP 450 is depicted for simplicity and does not include many components that may be present in other playlist files (e.g., M3U8 files). As shown, header 452 includes a #EXTM3U statement indicating the type of playlist/index file (e.g., extension to M3U). VP 452 is depicted as being in an extended M3U file format, including the comment character “#” preceding the tag “EXTM3U” in the first line 402

VP 452 further includes a listing of the available streams, attributes, and corresponding playlist locations/file names indicated by the tag “EXT-X-STREAM-INF” in stream identifiers 454-458. Other text files/protocols may be used. In addition, each of stream identifiers 454-458 includes a PROGRAM-ID attribute identifying the content item associate with the stream, and a BANDWIDTH attribute identifying the client bandwidth required to view the stream. For each of stream identifiers 454-458, the PROGRAM attribute includes a value of “1,” indicating that all streams correspond to a same content item. Stream identifier 454 includes a BANDWIDTH attribute value of “940000,” indicating the client bandwidth required to view/retrieve the associated stream. Stream identifier 456 includes a BANDWIDTH attribute value of “745984.” Stream identifier 458 includes a BANDWIDTH attribute value of “1341568.” The client device/media player may be configured to dynamically switch among the variant bandwidths based on an amount of bandwidth that the client device/media player can support at any given time.

Each of stream identifiers 454-458 may include a URL/URI to another playlist (e.g., playlist 400) that may be retrieved and used by client device 112 when the condition specified in a particular segment identifier is satisfied. For example, stream identifier 454 specifies that the available bandwidth for receiving the content stream is 940000 (e.g., 940 kbps) and a corresponding URI of 01.m3u8, which is playlist 400. In addition, as shown in FIG. 4B, each provided URI may include one or more attributes relating to, for example, the bitrate and resolution of the associated stream. For example, stream identifier 454 may indicate a bitrate of 400 kbps and a resolution of 704×480. This information may be used by client device 112 in selecting the appropriate stream for viewing. Client device 112 may be configured to dynamically switch among the variant streams based on an amount of bandwidth that the client device/media player can support at any given time. When a client device processes VP 450 and maintains the required bandwidth (e.g., to content server 106), client device 112 may obtain content segments 114 that are listed in playlist 400. Other observed bandwidths, may result in retrieval of content segments identified in other playlists 116 (e.g., 02.m3u8 or 03.m3u8).

Returning to FIG. 3, VP forwarding logic 320 may include logic configured to forward VP 117 generated by VP generating logic 315 to IMG server 110. In other implementations, VP forwarding logic 320 may include logic configured to store VP 117 in a location accessible to IMG server 110.

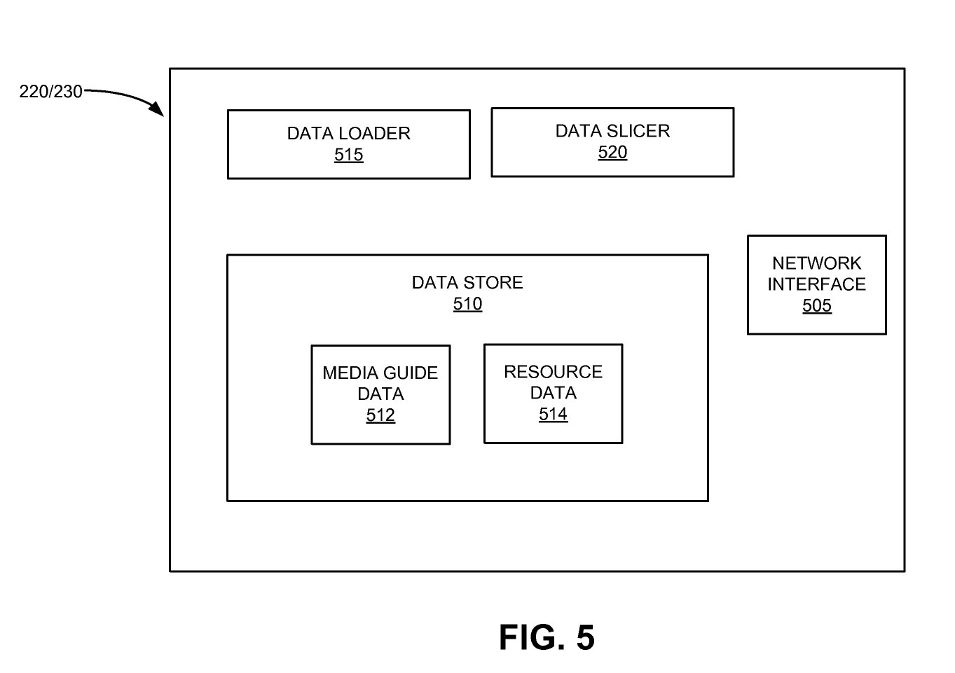

FIG. 5 is an exemplary functional block diagram of components implemented in IMG server 110. In an exemplary implementation, all or some of the components illustrated in FIG. 5 may be stored in memory 230. For example, referring to FIG. 5, memory 230 may include network interface 505, data store 510, data loader 515, and data slicer 520.

Network interface 505 may include one or more devices capable of communicating with the client device 112 via network 113, such as one or more servers, routers, etc. In particular, network interface unit 505 may be configured to provide content (e.g., data streams carrying content) to client device 112 over network 113. In some implementations, IMG server 110 may be implemented at a head-end unit (e.g., a super and/or local head-end unit), base station, central office, video hub office (“VHO”), video serving offices (“VSDs”), network node, other suitable locations, or at any combination of one or more of these locations. In some implementations, IMG server 110 may be logically separated from client device 112 by several entities, such as a super head-end, VHO, and/or VSO.

Consistent with embodiments described herein, network interface 505 may be configured to retrieve content from data store 510 and/or data slicer 520 for transmission to client device 112 via network 113. Accordingly, content stored in data store 510 may be made available over the network 113 by the network interface unit 505. The content may be provided at any suitable time, including in response to a request from the client device 112, at a predefined time or event, and periodically. The content may be provided in any suitable manner, including using in-band, out-of-band, or a combination of in-band and out-of-band communications. Examples of the IMG server 110 delivering IMG-related content to the client device 112 are described further below.

Data store 510 may include one or more data storage mediums, devices, or configurations and may employ any type, form, and combination of storage media, including hard disk drives, read-only memory, caches, databases, optical media, and random access memory. Data store 510 may include any known technologies useful for storing, updating, modifying, accessing, retrieving, and deleting content (e.g., media guide data, IMG data, etc.). For example, data store 510 may include media guide data 512, and resource data 514. In other implementations, data store 510 may store other content or types of content.

As used herein, the term “media guide data” may include any data that may be useful for generating and/or that may be included in an IMG user interface. Media guide data 512 may include data related to (e.g., descriptive of) media content (e.g., media content metadata), program data, data descriptive of media content ordering information, data related to stations providing media content (i.e., station data), data related to channels used for transmission of media content (i.e., channel data), data related to scheduling of media content such as broadcast times and channels (i.e., schedule data), media ratings information, credits, casts, reviews, episode information, series information, show information, pay-per-view information, and any other information associated with media content.

Resource data 514 may include any data that can be accessed and utilized by applications running on client device 112, including, but not limited to, configuration files, images (e.g., bitmaps), graphics, templates, and library files. By way of an example, resource data 514 may include images (e.g., channel and/or station logos) that can be used by an IMG application running on user device 112 to generate an IMG user interface.

User device 112 may receive the content stored in data store 510 from any suitable source, including one or more internal and/or external sources. In certain implementations, for example, media guide data 512 may be received in a raw form from a third-party data provider, processed, and stored in data store 510 as media guide data 512. Such a third-party data provider may include any suitable external source of data, including a provider of program guide information such as FYI Television, Inc. of Grand Prairie, Tex. or Tribune Media Services of Chicago, Ill.

As shown in FIG. 5, IMG server 110 may include a data loader 515 configured to receive variant playlist data (e.g., VP 117) from segmenter 104. In addition, data loader 515 may be configured to receive media data (e.g., programming data) from a third-party data provider, as described above.

Consistent with embodiments described herein, data loader 515 may be configured to associate received VPs 117 with corresponding media items/program items identified in received media data. The media data may be received from a third party provider or may be retrieved internally from data store 510. The media data and corresponding VP data may be stored in data store 510 for delivery to client device 112. For example, the VP associated with a particular media item (e.g., a movie) may be stored as metadata associated with an IMG entry corresponding the media item. In one implementation, selected information from the VP may be associated with the IMG entry. For example, VP information associated with the IMG entry may include the URIs of the playlist files, the bandwidth limits, and the output resolution information. In some implementations, only VP information for a single playlist may be provided in IMG data 118. For example, information relating to the lowest bandwidth version of the stream may be provided in IMG data 118. This may facilitate rapid channel or media changes.

As described below, upon selection of the media item via the IMG at client device 112, the corresponding VP (e.g., VP 117) may be simultaneously retrieved and processed. This eliminates a call to playlist server 108 and significantly increasing system responsiveness, while simultaneously reducing load on playlist server 108. When it is determined that the user has watched or consumed the media stream for more than a minimum period of time (e.g., 30 seconds), or that more than a minimum number of stream segments have been output, client device 112 may be configured to retrieve VP 117 from playlist server 108 in the typical manner. This allows higher bandwidth stream to be identified and selected.

In some implementations, IMG data 118 may be transmitted to client device 112 as “slices.” Consistent with such an implementation, IMG server 110 may include data slicer 520 configured to communicate with data loader 515, data store 510, and network interface unit 505.

Data slicer 520 may process media guide data 512 stored in data store 510, including generating one or more optimized configuration of media guide data 512 that can help conserve both memory and processing resources of client device 112. The optimized configuration (e.g., IMG data 118) may be forwarded to client device 112 via network interface unit 505 and network 113. Client device 112 may be configured to utilize the received IMG data 118 for generating an IMG user interface having VPs corresponding to particular media items identified in the guide.

An exemplary configuration of program guide data 240 that may be generated by data slicer 520 will now be described in detail. As used herein, the term “group” may be used to refer to any discrete grouping of data. A data group may be an electronic file (or simply “file”) or other discrete data instance. A data group may include one or more discrete data structures. One or more of the data structures may be organized into an array of data structures in a data group.

Data slicer 520 may be configured to organize media guide data 512 based on categories of the data. Accordingly, different categories of media guide data 512 may be stored in separate data structures and/or groups. Examples of categories that may be used include, but are not limited to, channel, lookup, schedule, series, episode, show, PPV, VOD, and cast/credit data.

Based on these categories, data slicer 520 may be configured to store the categories of media guide data into separate groups of data. For example, data slicer 520 may create a channel data group, a lookup data group, and at least one schedule data group and organize the data structures into these groups in accordance with predefined heuristics.

Once data slicer 520 has generated an optimized configuration of media guide data 512, IMG server 110 is ready and configured to provide at least a subset of the media guide data configuration to client device 112 as IMG data 118. For example, IMG server 110 may provide a number of data corresponding to discrete units of time (e.g., days) to client device 112 via network 113.

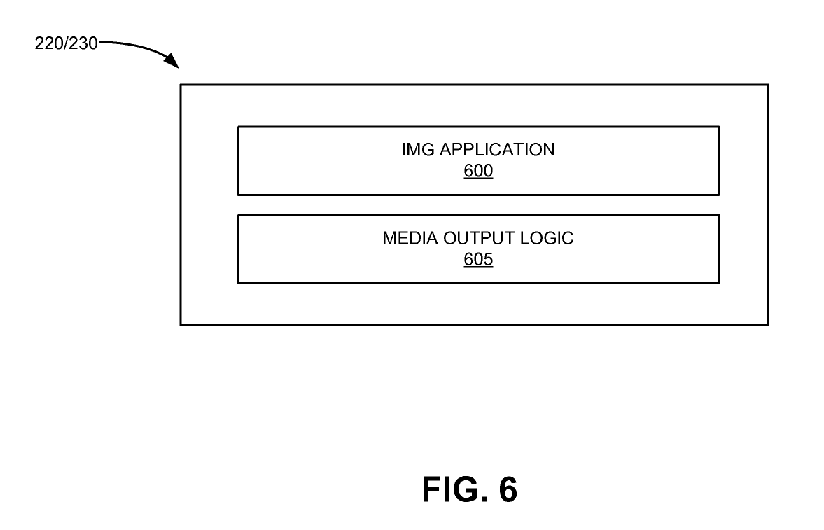

FIG. 6 is an exemplary functional block diagram of components implemented in client device 112 of FIG. 1. In an exemplary implementation, all or some of the components illustrated in FIG. 6 may be stored in memory 230. For example, referring to FIG. 6, memory 230 may include IMG application 600 and media output logic 605. In one embodiment, IMG application 600 and/or media output logic 605 may be implemented by processing logic 220 executing one or more programs stored in memory 230.

As described above, IMG application 600 may be configured to receive IMG data 118 from IMG server 110. Consistent with embodiments described herein, IMG data 118 may include data used to generate an IMG user interface and may include VPs 117 corresponding to one or more media items presented in the IMG user interface.

IMG application 600 may be further configured to, upon receipt of a user selection of a media item corresponding to a particular VP 117, extract the VP from the IMG data 118. As described above in relation to FIG. 4B, VP 117 includes identifiers, attributes, and locations corresponding with available variant media streams associated with the selected media item. IMG application 600 may, based on usage characteristics, such as available bandwidth, stream bitrate, output resolution, etc., identify a particular media stream for output by media output logic 605. In addition, IMG application 600 may pass (or otherwise make available) VP 117 to media output logic 605, for dynamic stream selection during playback of the selected media item.

Media output logic 605 may include logic to communicate with playlist server 108 and content server 106 to retrieve playlists 116 corresponding to dynamically selected variant media streams and their associated content. Media output logic 605 may further include logic and/or processing to output received stream segments 114 via an output device, such as output device 270 (e.g., a television, monitor, speakers, etc.).

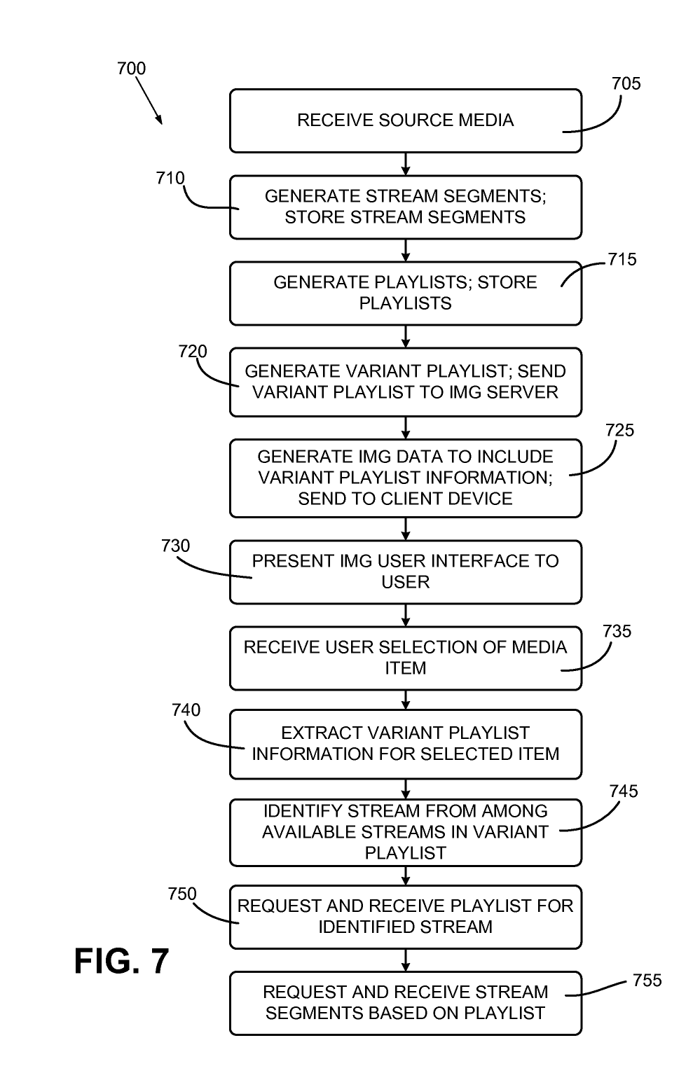

FIG. 7 is a flow diagram illustrating exemplary processing 700 associated with the above-described features of FIGS. 1-6. Processing 700 may begin with content segmenter 104 receiving/retrieving a source media item from content source 102 (block 705). As described above, in one implementation, the content may have been sent as an MPEG-2 Transport Stream. Upon receiving the source content, segmenter 104 may partition the content stream into one or more sets of stream segments 114, and send segments 114 to content server 106 (block 710).

In addition, segmenter 104 may generate playlists 116 that describe segments 114, and send playlists 116 to playlist server 108 (block 715). As described above, a playlist 116 is generated for each different variant stream generated by segmenter 104. Segmenter 104 further generates VP 117 identifying the available playlists 116 associated with the source content and any attributes corresponding to their selection and send VP 117 to IMG server 110 (block 720).

IMG server 110 may generate IMG data 118 to include information relating to various media items, schedules, etc. and send IMG data 118 to client device 112 (block 725). As described above, IMG data 118 may be configured to include VP 117.

Client device 112 may receive IMG data 118 and present an IMG user interface to a user (block 730). For example, IMG application 600 may receive IMG data 118 periodically via network 113. IMG application 600 may receive a user selection of an available media item (block 735). In response, IMG application 600 may extract VP 117 associated with the selected media item (block 740). IMG application 600 may, based on usage and/or network characteristics associated with client device 112 (e.g., network bandwidth, output resolution, etc.), identify a particular stream from among a number of available media streams identified in VP 117 (block 745). IMG application 600 and/or output logic 605 may, based on the identified stream, request/retrieve a corresponding playlist 116 based on information in VP 117 (block 750). Output logic 605 may retrieve content segments based on the retrieved playlist 116 (block 755).

By providing a variant playlist and related information in IMG or program guide data, the above-described systems and methods significantly reduce server loads by eliminating the need for client devices to dynamically request and receive variant playlists from network server resources. In addition, providing a variant playlist in IMG or program guide data for use by the client device upon selection of a particular media item significantly decreases the time required to begin outputting the selected media stream.

The foregoing description of implementations provides illustration, but is not intended to be exhaustive or to limit the implementations to the precise form disclosed. Modifications and variations are possible in light of the above teachings or may be acquired from practice of the teachings.

In addition, while series of blocks have been described with regard to an exemplary process illustrated in FIG. 7, the order of the blocks may be modified in other implementations. In addition, non-dependent blocks may represent acts that can be performed in parallel to other blocks.

It will be apparent that aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

Further, certain portions of the implementations have been described as “logic” that performs one or more functions. This logic may include hardware, such as a processor, a microprocessor, an application specific integrated circuit, or a field programmable gate array, software, or a combination of hardware and software.

No element, act, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. A computing-device implemented method, comprising:
generating two or more media streams based on a source media item, wherein the two or more media streams each include a number of stream segments;
storing the stream segments for each of the two or more media streams on a content server;
generating playlist files for each of the two or more media streams, wherein the playlist files identify locations of the associated stream segments on the content server;
storing the playlist files, for each of the two or more media streams, on a playlist server;
generating a variant playlist file that identifies the locations and attributes associated with each of the playlist files;
inserting information based on the variant playlist file into media guide data; and
transmitting the media guide data to a client device via a network.

2. The method of claim 1, wherein the attributes comprise at least network bandwidth attributes associated with each of the two or more media streams.

3. The method of claim 1, wherein the information based on the variant playlist file comprises playlist location and bandwidth information for at least one of the two or more media streams.

4. The method of claim 3, wherein the information based on the variant playlist file comprises playlist location and bandwidth information for a media stream, from the at least two media streams having a lowest bandwidth attribute.

5. The method of claim 1, wherein the media guide data comprises information relating to available media items for a particular period of time.

6. The method of claim 1, wherein transmitting the media guide data is performed periodically.

7. The method of claim 1, further comprising:
receiving a request from the client device for a particular playlist file identified in the media guide data;
transmitting the particular playlist file to the client device;
receiving a request from the client device for stream segments identified in the particular playlist from the content server; and
transmitting the requested stream segments to the client device for output to a user.

8. A computing-device implemented method, comprising:
receiving media guide data from a media guide server via a network,
wherein the media guide data includes information relating to a number of available media items, and wherein the media guide data further includes playlist information relating to at least one available playlist file associated with a particular media item;
receiving a user selection of the particular media item;
requesting the playlist file from a playlist server via the network based on the playlist information;
receiving the playlist file from the playlist server, wherein the playlist file includes locations of stream segments corresponding to the selected media item; and
requesting the stream segments from a content server via the network based on the received playlist file.

9. The method of claim 8, wherein the media guide data further includes variant playlist information,
wherein the variant playlist information includes playlist information relating to more than one available playlist file associated with the particular media item.

10. The method of claim 9, further comprising:
determining a characteristic associated with the network, wherein requesting the playlist file comprises requesting one of the more than one playlist files from the playlist server via the network based on at least one of the network characteristics.

11. The method of claim 10, wherein the at least one network characteristic comprises available bandwidth.

12. The method of claim 8, further comprising:
receiving and outputting at least one of the stream segments;
subsequent to outputting the at least one of the stream segments, requesting a variant playlist file from the playlist server, wherein variant playlist information includes playlist information relating to more than one available playlist file associated with the particular media item;
determining a characteristic associated with the network; and
requesting a selected one of the more than one playlist file from the playlist server via the network based on the network characteristics.
receiving the selected one of the more than one playlist files from the playlist server; and
requesting the stream segments from the content server via the network based on the received selected one of the more than one playlist file.

13. The method of claim 12, further comprising:
requesting the variant playlist file from the playlist server based on a determination that more than a predetermined number of stream segments have been output.

14. A network device comprising:
one or more processors configured to:
generate two or more media streams based on a source media item, wherein the two or more media streams each include a number of stream segments;
store the stream segments for each of the two or more media streams on a content server;
generate playlist files for each of the two or more media streams, wherein the playlist files identify locations of the associated stream segments on the content server;
store the playlist files for each of the two or more media streams on a playlist server;
generate a variant playlist file that identifies the locations of each of the playlist files on the playlist server and attributes associated with each of the playlist files; and
insert information based on the variant playlist file into media guide data; and an interface configured to:
send, via a network, the media guide data to a user device.

15. The network device of claim 14, wherein the information based on the variant playlist file comprises playlist location and bandwidth information for at least one of the two or more media streams.

16. The network device of claim 14, wherein the interface is further configured to send the media guide data on a periodic basis.

17. The network device of claim 14, wherein the interface is further configured to:
receive a request from the user device for a particular playlist file identified in the media guide data;
transmit the particular playlist file to the user device;
receive a request from the user device for stream segments identified in the particular playlist from the content server; and
transmit the stream segments to the user device for presentation to a user.

18. A network device, comprising:
an interface configured to:
receive media guide data from a media guide server via a network,
wherein the media guide data includes information relating to a number of available media items, and wherein the media guide data further includes playlist information relating to at least one available playlist file associated with a particular media item of the available media items; and
at least processor configured to:
receive a user selection of the particular media item,
request the playlist file from a playlist server via the interface based on the playlist information;
receive the playlist file from the playlist server via the interface, wherein the playlist file identifies locations, on a content server, of stream segments corresponding to the selected playlist; and
request the stream segments from the content server via the interface based on the received playlist file.

19. The network device of claim 18, wherein the media guide data further includes variant playlist information,
wherein the variant playlist information includes playlist information relating to more than one available playlist file associated with the particular media item.

20. The network device of claim 18, wherein the processor is further configured to:
receive at least one of the stream segments from the content server via the interface;
output the at least one of the stream segments via an output device;
subsequent to outputting the at least one of the stream segments, request a variant playlist file from the playlist server via the interface, wherein variant playlist information includes playlist information relating to more than one available playlist file associated with the particular media item;
determine a characteristic associated with the network;
request a selected one of the more than one playlist file from the playlist server via the interface based on the network characteristics; and
receive the selected one of the more than one playlist file from the playlist server; and
request the stream segments from the content server via the network based on the received selected one of the more than one playlist file.
